(19) United States
(12) Patent Application Publication
(10) Pub. No.: US 2004/0062621 A1
(43) Pub. Date: Apr. 1, 2004

(54) Retainer for positioning fasteners in parts, structural members, and the like

(75) Inventors: Alan Honggen Jiang, Sheboygan Falls, WI (US); David S. Hoyte, Sheboygan, WI (US); Kwok-Sang Chui, Columbus, IN (US); Charles M. Waldon, Sheboygan, WI (US)

Correspondence Address: Derek C. Stettner, Michael Best & Friedrich LLP, 100 East Wisconcin Avenue, Milwaukee, WI, 53202-4108, US

(73) Assignee: J. L. French Automotive Castings, Inc., Sheboygan, WI

(21) Appl. No.: 10/259,121

(22) Filed: Sep. 27, 2002

(51) Int. Cl. F16B 21/18

(52) U.S. Cl. 411/353

(57) ABSTRACT

A retainer for pre-attaching fasteners within the bore of a structural member, part, or similar item. The retainer includes a cylindrical body having a main axis, an opening into which a fastener may be inserted, and a plurality of solid walls positioned co-axially around the main axis. In one embodiment, the retainer may be made of plastic such as a thermal plastic which is relatively flexible and soft enough not to scratch or damage metal surfaces or protective coatings. Each wall has a top portion and a bottom portion and is separated from at least one of the other plurality of walls by a gap. The retainer also has a first beveled ring located near the top portion of each of the walls, and a second beveled ring located near the bottom portion of each of the walls.

### BACKGROUND OF THE INVENTION

The present invention relates to retainers used to hold or position a fastener, such as a screw or bolt, in the bore of a structural member, part, or similar item. More particularly, embodiments of the invention relate to a retainer having features to facilitate the insertion of the retainer into a bore and to accept fasteners of varying dimensions.

Retainers are used in a variety of applications, but are particularly suited for use in automated assembly systems where one member is joined to another member. For example, oil pans used in automobile engines can be secured more efficiently to the bottom of engines if the fasteners used to secure an oil pan and engine together are already properly positioned within the bores of the oil pan when the oil pan is moved into position to be bolted to an engine block. In some cases, an automated system or robotic end effector aligns itself with the fasteners (in this case bolts) and drives them into bores in the engine block, thereby securing the parts together. In other cases, an assembly line worker using an air wrench or similar tool drives the bolts into the bores. In either case, since the bolts are held in position by the retainer they do not need to be held in place by the robot or worker and will not fall out of the bores in the oil pan in the event that the fastening must be done with the parts positioned such that gravity will act to pull the bolts from the bores.

### SUMMARY OF THE INVENTION

Although a variety of retainers useful for holding fasteners exist, they are not entirely satisfactory. Many retainers are made from metal, which can scratch and damage the surfaces of parts. Metal retainers can also damage protective and rust-inhibiting coatings that may be applied to parts and fasteners. In addition, many retainers are difficult to insert into the bores of the part or member that will be fastened to another part or member. Furtherstill, many retainers are designed to accommodate only one size of fastener within a relatively small dimension tolerance.

Accordingly, in one embodiment, the invention provides a retainer for pre-attaching fasteners within the bore of a structural member, part, or similar item. The retainer includes a cylindrical body having a main axis, an opening into which a fastener may be inserted, and a plurality of solid walls positioned co-axially around the main axis. In one embodiment, the retainer may be made of plastic such as a thermal plastic which is relatively flexible and soft enough not to scratch or damage metal surfaces or protective coatings. Each wall has a top portion and a bottom portion and is separated from at least one of the other plurality of walls by a gap. The retainer also has a first beveled ring located near the top portion of each of the walls, and a second beveled ring located near the bottom portion of each of the walls.

In another embodiment, the invention provides a retainer with a body. The body has a length, a plurality of solid walls having outer and inner surfaces arranged such that the outer surfaces define a cylindrical structure and the inner surfaces define an aperture extending the length of the body, and at least one beveled ring circumscribing the outer surfaces of the solid walls. The body is operable to retain a fastener in a bore of a member so that when the fastener in the member is aligned over a bore of a second structural member, the two structural members may be joined by pushing the fastener through the retainer to engage the second structural member.

In another embodiment, the invention provides a method of positioning a fastener in a bore of a part using a retainer, where the retainer has a length, and a plurality of solid walls. Each wall includes outer and inner surfaces, the outer surfaces define a cylindrical structure, and the inner surfaces define an aperture extending the length of the retainer. The retainer has at least one bevel-shaped ring circumscribing the outer surfaces of the solid walls and defining a first diameter of the body. The inner surfaces have a convex shape and define a second diameter that is smaller than the first diameter. The method includes creating a fastener-retainer assembly by inserting the shaft of the fastener into the aperture such that the shaft engages the inner surfaces of the solid walls, the walls flexing to accommodate the shaft of the fastener; and inserting the fastener-retainer assembly into the bore of the part, the bevel-shaped-ring facilitating centering of the fastener-retainer assembly in the bore and reducing sliding interference between the retainer and the bore.

In another embodiment, the invention provides a retainer having a body made of a thermoplastic material. The body has a length, and a plurality of flexible, solid walls having inner and outer surfaces arranged such that the outer surfaces define a cylindrical structure and the inner surfaces define an aperture extending the length of the body. The retainer also has a plurality of rings circumscribing the outer surfaces of the solid walls.

As is apparent from the above, it is an advantage of the present invention to provide a retainer with features that facilitate insertion of the retainer in a bore, reduce damage to surfaces and coatings, and that accommodates fasteners of varying size. Other features and advantages of the present invention will become apparent by consideration of the detailed description and accompanying drawings.

### BRIEF DESCRIPTION OF THE DRAWINGS

In the drawings:

FIG. 1 is a perspective view of a retainer of one embodiment of the invention.

FIG. 2 is an end, perspective view of the retainer shown in FIG. 1.

FIG. 3 is a top view of the retainer shown in FIG. 1.

FIG. 4 is a cross-sectional view of the retainer shown in FIG. 1 taken along the line 4-4 in FIG. 3.

FIG. 5 is a cross-sectional view of the retainer shown in FIG. 1 taken along the line 5-5 in FIG. 2.

FIG. 6 is a side view of the retainer shown in FIG. 1.

FIG. 7 is a perspective view of a fastener-retainer assembly.

FIG. 8 is a perspective view of a fastener-retainer assembly inserted into a bore of an exemplary part, an oil pan for an internal combustion engine.

### DETAILED DESCRIPTION

Before any embodiments of the invention are explained in detail, it is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “connected,” “coupled,” and “mounted” are used broadly and encompass both direct and indirect connection, coupling, and mounting. In addition, the terms “connected” and “coupled” are not restricted to physical or mechanical connections or couplings.

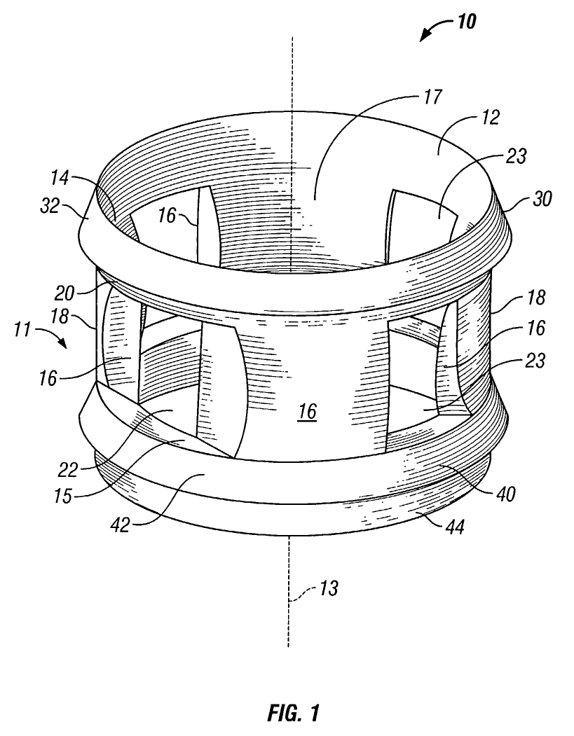

FIG. 1 illustrates a retainer 10 of one embodiment of the invention. The retainer 10 includes a main body 11. In one embodiment of the invention, the main body is made of plastic material such as a thermoplastic material and is generally cylindrically shaped. When constructed of plastic, the retainer 10 does little damage to coatings and metal surfaces of the parts to be joined and fasteners used to join the parts. The main body 11 may be molded or otherwise formed as a single or unitary piece. The main body 11 has an opening or aperture 12 that extends substantially an entire length L of the main body 11. The main body 11 also includes a longitudinal or main axis 13, first and second ends 14 and 15 and a plurality of solid walls 16, which in the embodiment shown are positioned co-axially around the main axis 13. Each wall 16 includes an inner surface 17 and an outer surface 18, and a top portion 20 and a bottom portion 22. The inner surface 17 of each wall is curved or arched toward the axis 13. In one embodiment of the invention, the inner surface 17 of each wall 16 has a convex curve.

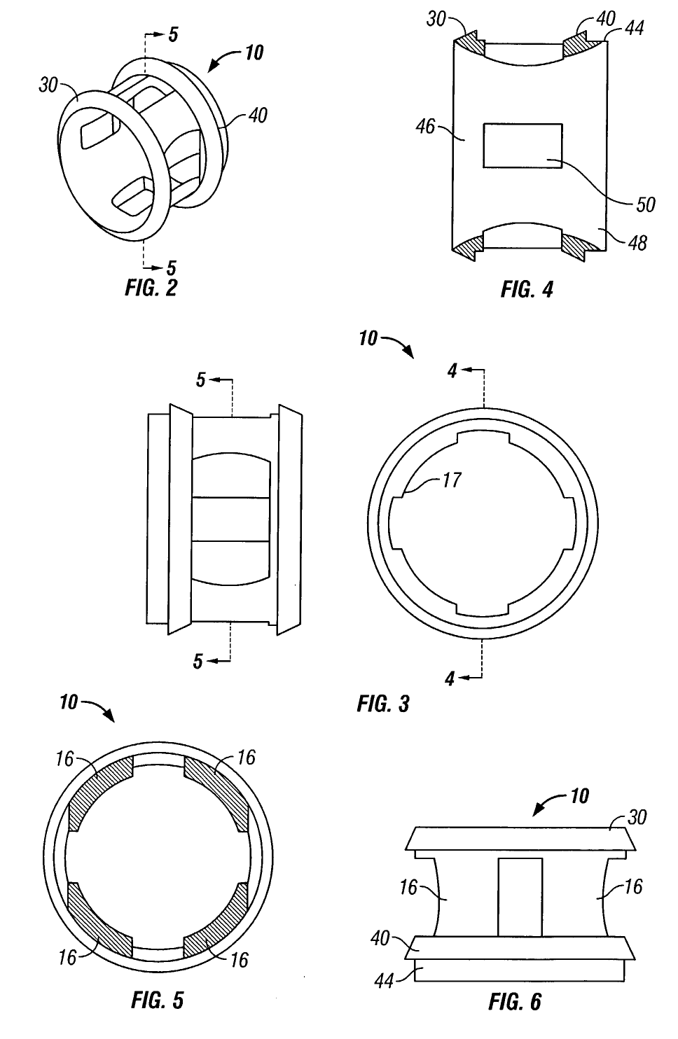

As best seen by reference to FIG. 3, the aperture 12 has a first diameter D1 and a second diameter D2 that is smaller than the first diameter. The dimension of the aperture 12 changes due to the curved shape of the inner walls 17. As a result, the aperture will have a first circumference near a first beveled ring (discussed below) located near the first end 14 and a smaller second circumference where the curved or arched inner surfaces 17 of the walls 16 extend toward the axis 13.

The walls 16 are preferably elastic or flexible so that when a shaft of a fastener (discussed further below) is inserted into the aperture 12 the walls compress, deform, and/or move to accommodate the fastener. The curved shape and flexible nature of the walls 16 help the retainer 10 maintain a secure frictional engagement of a fastener (discussed further below) that is inserted into the aperture 12. The curved shape and flexible nature of the walls 16 also permit the retainer 10 to accommodate variations in actual fastener size, which is, in general, accurate within a predetermined manufacturing or size tolerance. In the embodiment shown, each of the walls 16 is separated from the next adjacent wall by a gap 23, which in the embodiment shown takes the form of a rectangularly-shaped opening. However, square, oval, or other shaped openings could be used.

In the embodiment shown, a first slanted or beveled ring 30 is positioned near and circumscribes the top portion 20 of each wall 16. The first slanted or beveled ring 30 has a slanted or angled surface or bevel 32. Preferably, the bevel 32 is angled at about 45° (or 135° with respect to horizontal). The first beveled ring 30 facilitates insertion of the retainer 10 into the bore of a member or part (an example of which is discussed below.) The retainer 10 may include a second beveled ring 40 positioned near the second end 15 of the main body 11, opposite the first end 14. The second beveled ring 40 circumscribes the bottom portions of the walls 16. Like the first beveled ring 30, the second beveled ring 40 has a slanted or angled surface or bevel 42. Preferably, the bevel 42 is angled at about 45° (or 135° with respect to horizontal). The main body 11 has a stepped portion 44 adjacent the second beveled ring 40.

As best seen by reference to FIG. 4, the first beveled ring has a diameter 46 and the second beveled ring has a diameter 48. In the embodiment shown, the diameters 46 and 48 are substantially equal to each other. Further, the diameters 46 and 48 are greater than a diameter 50, measured at a point where the inner surfaces 17 are closest to the axis 13.

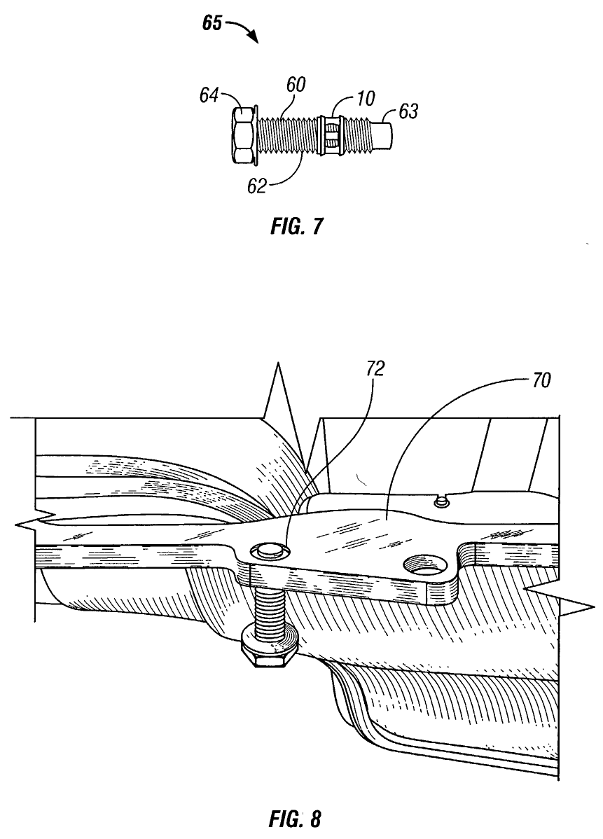

FIG. 7 illustrates the retainer 10 placed on an exemplary fastener 60 in the form of a bolt. The bolt includes a shaft 62 and a head 63, and a tip 64. To pre-attach or otherwise position or hold a fastener in a bore of a part, the fastener 60 and in this case, more particularly, the shaft 62 is inserted into the aperture 12 such that the tip 64 is inserted into the aperture 12 at the second end 15 of the main body 11 and the stepped portion 44 faces the head 63. When inserted into the aperture 12, the shaft 62 engages the inner surfaces 17 of the walls 16 and the walls deform, flex, or otherwise accommodate the shaft of the fastener in the aperture 12.

Once so inserted, the fastener 60 and retainer 10 form a fastener-retainer assembly 65. To pre-attach or otherwise hold or position the fastener 60 in a part or member (such as an oil pan 70), the fastener-retainer assembly 65 is inserted into the bore of the part, such as a bore 72 formed in a flange 74). The bevel-shaped rings 30 and 40 facilitate centering of the fastener-retainer assembly 65 in the bore 72. The bevel-shaped rings also reduce sliding interference between the retainer 10 and edge of bore 72. For example, if the rings 30 and 40 had square shapes, a direct flat-face-to-flat-face interaction between the retainer and the edge of the bore 72 could occur, requiring repositioning of the fastener-retainer assembly before it could be inserted into the bore 72. The beveled rings of the retainer 10 act like ramps allowing the fastener-retainer assembly to slide more readily over an edge if the assembly is slightly mis-aligned with the bore 72.

Once the fastener retainer 60 is inserted in a subject bore (such as the bore 72) of a subject member or part (such as the oil pan 72), the part may be aligned with a second part such that the bore of the part aligns with a bore in the second part. Once the parts are aligned, the fastener may be screwed, driven, or otherwise positioned into the bore of the second part. As the fastener is positioned in the bore of the second part, the shaft moves through the aperture 11 of the retainer 10. Once the parts are secured, the retainer 10 remains in place in the bore of the first part.

It should be understood, of course, that most parts or members such as the oil pan 70 require several fasteners (particularly bolts for the exemplary oil pan) to be properly secured to an another part (which would be an engine block for the oil pan). Thus, retaining or holding bolts in place prior to assembly is important to achieve fast and easy assembly. Otherwise, each fastener must be held by hand or some other mechanism as it is driven into a desired position.

As can be seen from the above, embodiments of the present invention provide a retainer for positioning or holding a fastener in a part or similar item.

Various features and advantages of the invention are set forth in the following claims.

What is claimed is:

1. A retainer suitable for pre-attaching fasteners within the bore of a structural member, the retainer comprising:
a cylindrical body having
a main axis,
an opening into which a fastener may be inserted,
a plurality of solid walls positioned co-axially around the main axis, each wall having a top portion and a bottom portion and separated from at least one of the other plurality of walls by a gap,
a first beveled ring located near the top portion of each of the walls, and
a second beveled ring located near the bottom portion of each of the walls.

2. A retainer as claimed in claim 1, where each wall has an inner surface that is arched to extend toward the main axis.

3. A retainer as claimed in claim 2, wherein the opening extends the entire length of the cylindrical body and has a first circumference near the first beveled ring and a second circumference that is smaller than the first circumference, the second circumference located in proximity to where the arched inner surfaces of the walls extend toward the main axis.

4. A retainer as claimed in claim 1, wherein the cylindrical body is made from a thermoplastic material.

5. A retainer as claimed in claim 1, wherein each of the first and second beveled rings are beveled at an angle of about 45°.

6. A retainer comprising:
a body having
a length,
a plurality of solid walls having outer and inner surfaces arranged such that the outer surfaces define a cylindrical structure and the inner surfaces define an aperture extending the length of the body; and
at least one beveled ring circumscribing the outer surfaces of the solid walls,
whereby the body is operable to retain a fastener in a bore of a member so that when the fastener in the member is aligned over a bore of a second structural member, the two structural members may be joined by pushing the fastener through the retainer to engage the second structural member.

7. The retainer of claim 6, where the at least one beveled ring is beveled at an angle of about 45°.

8. The retainer of claim 7, comprising first and second beveled rings, the first beveled ring having a first diameter and the second beveled ring having a second diameter, the first and second diameters being substantially equal to one another.

9. The retainer of claim 8, wherein the body has first and second ends and the first ring is positioned near the first end and the second ring is positioned near the second end.

10. A retainer comprising:
a body made of a thermoplastic material, the body having
a length,
a plurality of flexible, solid walls having inner and outer surfaces arranged such that the outer surfaces define a cylindrical structure and the inner surfaces define an aperture extending the length of the body; and
a plurality of rings circumscribing the outer surfaces of the solid walls.

11. The retainer of claim 10, where the inner surfaces of the walls form convex curves.

12. The retainer of claim 10, where each ring is has a slanted surface, each slanted surface angled at about 45°.

13. The retainer of claim 11, wherein the plurality of rings includes first and second rings and the first and second rings are located at opposite ends of the cylindrical body.

14. A retainer comprising:
a unitary, cylindrical body having
a length,
an axial opening extending the entire length
a plurality of solid walls, each solid wall having an inner and outer surface, the inner surface forming a convex curve; and
one or more beveled rings circumscribing the outer surfaces of the solid walls.

15. The retainer of claim 14, where each ring has a surface angled at about at 45°.

16. The retainer of claim 15, comprising first and second rings beveled rings, the first and second rings located at opposite ends of the cylindrical body.

17. A retainer comprising:
a body made of a thermoplastic material, the body having
a plurality of flexible solid walls having outer and inner surfaces arranged such that the outer surfaces define a cylindrical structure and the inner surfaces define an aperture, the inner surfaces having a convex curve; and
two beveled rings circumscribing the outer surfaces of the solid walls.

18. The retainer of claim 17, where each ring is angled at about 45°.

19. A retainer comprising:
a unitary, cylindrical body having a length, an axial opening extending the entire length, a plurality of solid walls, each having an outer surface, and beveled rings circumscribing the outer surfaces of the solid walls.

20. The retainer of claim 19, where each ring is angled at 45°.

21. The retainer of claim 20, where two of the plurality of beveled rings are located at opposite ends of the cylindrical body.

22. A method of positioning a fastener in a bore of a part using a retainer, the retainer having a length, a plurality of solid walls, each wall including outer and inner surfaces, the outer surfaces defining a cylindrical structure and the inner surfaces defining an aperture extending the length of the retainer, and at least one bevel-shaped ring circumscribing the outer surfaces of the solid walls and defining a first diameter of the body, the inner surfaces having a convex shape and defining a second diameter that is smaller than the first diameter, the method comprising:
creating a fastener-retainer assembly by inserting the shaft of the fastener into the aperture such that the shaft engages the inner surfaces of the solid walls, the walls flexing to accommodate the shaft of the fastener; and
inserting the fastener-retainer assembly into the bore of the part, the bevel-shaped-ring facilitating centering of the fastener-retainer assembly in the bore and reducing sliding interference between the retainer and the bore.

23. A method as claimed in claim 22, further comprising:
aligning the part with a second part such that the bore of the part aligns with a bore in the second part; and
driving the fastener into the bore of the second part, by moving the shaft through the aperture.
